(19) United States
(12) Patent Application Publication
(10) Pub. No.: US 2025/0214652 A1
(43) Pub. Date: Jul. 3, 2025

(54) VEHICLE BODY STRUCTURE WITH A SLIDING DOOR

(71) Applicants: HYUNDAI MOTOR COMPANY, Seoul (KR); KIA CORPORATION, Seoul (KR)

(72) Inventor: Seung Min Kang, Hwaseong-si (KR)

(73) Assignees: HYUNDAI MOTOR COMPANY, Seoul (KR); KIA CORPORATION, Seoul (KR)

(21) Appl. No.: 18/654,546

(22) Filed: May 3, 2024

(30) Foreign Application Priority Data
Dec. 27, 2023 (KR) 10-2023-0193348

(51) Int. Cl. B62D 21/15; B60J 5/06; B62D 25/02; B62D 25/04; E05D 15/06

(52) U.S. Cl. CPC B62D 21/157; B60J 5/06; B62D 25/025; B62D 25/04; E05D 15/0686; E05Y 2900/531

(57) ABSTRACT

A vehicle body structure includes a rail member integrated with a door rail, a plurality of pillars coupled to an upper side of the rail member, and a plurality of body cross members connected to a lateral side of the rail member.

### CROSS-REFERENCE TO RELATED APPLICATION

The present application claims priority to Korean Patent Application No. 10-2023-0193348 filed on Dec. 27, 2023, the entire contents of which are incorporated herein for all purposes by this reference.

### BACKGROUND

### Field of the Disclosure

The present disclosure relates to a technology associated with a vehicle body structure for a vehicle equipped with a sliding door.

### Description of the Related Art

A sliding door for a vehicle is opened or closed while sliding in a forward/rearward direction at a lateral side of a vehicle body.

In order to mount the sliding door on the vehicle body, a door rail needs to be provided on the vehicle body to guide a forward/rearward sliding movement of the sliding door.

A large number of components are required to mount the door rail. Additionally, it is difficult to ensure sufficient rigidity because it is necessary to ensure a movement route for a door arm configured to connect the sliding door and the door rail.

The foregoing explained as the background of the present disclosure is intended merely to aid in understanding the background of the present disclosure. Therefore, the foregoing is not intended to mean that the present disclosure falls within the purview of the related art that is already known to those having ordinary skill in the art.

### SUMMARY

Accordingly, the present disclosure has been made keeping in mind the above problems occurring in the related art. The present disclosure is intended to provide a vehicle body structure with a sliding door. The vehicle body structure is capable of ensuring sufficient rigidity of a portion where a door rail for sliding a sliding door is provided. Additionally, the vehicle body structure is capable of facilitating an assembly process and reducing costs by significantly reducing the number of necessary components.

According to one aspect, a vehicle body structure with a sliding door is provided. The vehicle body structure includes a rail member integrated with a door rail and a plurality of pillars coupled to an upper side of the rail member. The vehicle body structure also includes a plurality of body cross members connected to a lateral side of the rail member.

The rail member may include a rail forming part configured to define the door rail and a strength reinforcement part integrally provided below the rail forming part and configured to define a transverse cross-section of a vehicle body that is a closed cross-section.

The door rail may be formed at an upper side of the rail forming part. An opening portion may be provided between the door rail and the strength reinforcement part and opened to the outside of the vehicle body.

The rail member may have a plurality of pillar coupling portions protruding upward from the rail forming part and coupled to the plurality of pillars, respectively, while defining closed cross-sections.

A pillar of the plurality of pillars may be formed so that a cross-section perpendicular to a longitudinal direction of the pillar is formed as a closed cross-section. A first pillar lower end of the pillar, which include adjacent two or more outer peripheral walls among a plurality of outer peripheral walls that defines the closed cross-section of the pillar, may protrude relatively further downward than a second pillar lower end. The second pillar lower end may include the remaining adjacent two or more outer peripheral walls. A pillar coupling portion of the plurality of pillar coupling portions of the rail member coupled to the pillar may include a first member upper end protruding upward so as to be coupled to the second pillar lower end of the pillar while overlapping the second pillar lower end. The pillar coupling portion may also include a second member upper end recessed relatively downward from the first member upper end so as to be coupled to the first pillar lower end of the pillar while overlapping the first pillar lower end.

The rail member may have a plurality of cross member coupling portions protruding laterally toward the plurality of body cross members and coupled to the plurality of body cross members, respectively, while defining closed cross-sections.

A body cross member of the plurality of body cross members may be formed so that a cross-section perpendicular to a longitudinal direction of the body cross member is formed as a closed cross-section. A first cross member lateral end of the body cross member, which includes adjacent two or more outer peripheral walls among a plurality of outer peripheral walls that defines the closed cross-section of the body cross member, may protrude relatively further laterally than a second cross member lateral end of the body cross member. The second cross member lateral end may include the remaining adjacent two or more outer peripheral walls. A cross member coupling portion of the plurality of cross member coupling portions of the rail member coupled to the body cross member may include a first member lateral end protruding further laterally so as to be coupled to the second cross member lateral end of the body cross member while overlapping the second cross member lateral end. The cross member coupling portion may further include a second member lateral end recessed relatively laterally from the first member lateral end so as to be coupled to the first cross member lateral end of the body cross member while overlapping the first cross member lateral end.

The rail member may be coupled to a side sill and elongated in a forward/rearward direction of the vehicle body. A side sill coupling portion may be provided at a front side of the rail member and coupled to the side sill while defining a closed cross-section.

The side sill may be formed so that a cross-section perpendicular to a longitudinal direction of the side sill is formed as a closed cross-section. A first side sill rear end, which includes adjacent two or more outer peripheral walls among a plurality of outer peripheral walls that defines the closed cross-section of the side sill, may protrude relatively further rearward than a second side sill rear end of the side sill. The second side sill rear end may include the remaining adjacent two or more outer peripheral walls. The side sill coupling portion of the rail member coupled to the side sill may include a first member front end protruding further forward so as to be coupled to the second side sill rear end of the side sill while overlapping the second side sill rear end. Additionally, the side sill coupling portion may include a second member front end recessed relatively rearward from the first member front end so as to be coupled to the first side sill rear end of the side sill while overlapping the first side sill rear end.

The plurality of pillars coupled to the rail member may include a B-pillar and a C-pillar.

The plurality of pillars coupled to the rail member may include a C-pillar and an A-pillar. A B-pillar between the A-pillar and the C-pillar may be excluded.

The rail member may further include a side flange extending toward the inside of a vehicle and coupled to a floor longitudinal member.

The side flange of the rail member may be shaped to surround a sidewall and a lower portion of the floor longitudinal member.

A reinforcement panel may be further provided between a lower side of the floor longitudinal member and the rail member and may define a closed cross-section together with the side flange to reinforce rigidity.

According to the present disclosure, it is possible to ensure sufficient rigidity of the portion where the door rail for sliding the sliding door is provided. Additionally, according to the present disclosure, it is possible to facilitate the assembling process and reduce costs by significantly reducing the number of necessary components.

### BRIEF DESCRIPTION OF THE DRAWINGS

FIG. 1 is a view illustrating a vehicle body structure with a sliding door according to the present disclosure.

FIG. 2 is a view illustrating a state in which a floor panel is excluded from the vehicle body in FIG. 1.

FIG. 3 is a view illustrating a rail member of the vehicle body in FIG. 1.

FIG. 4 is a cross-sectional view taken along line IV-IV of the rail member in FIG. 3.

FIG. 5 is a view illustrating the rail member in FIG. 4 when viewed from the rear side.

FIG. 6 is a view illustrating the rail member, a side sill, a B-pillar, and a body cross member in FIG. 2.

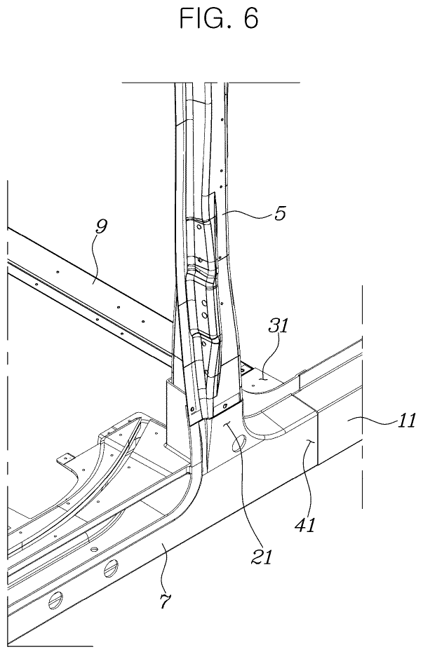

FIG. 7 is an exploded perspective view of FIG. 6.

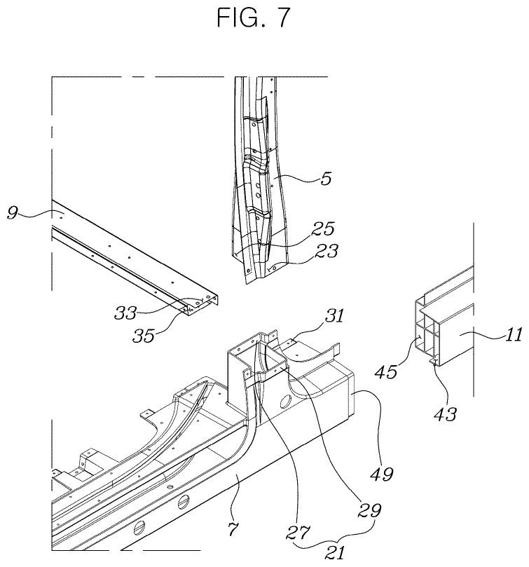

FIG. 8 is a view illustrating the components in FIG. 7 when viewed from the top sides of the interior of the vehicle body.

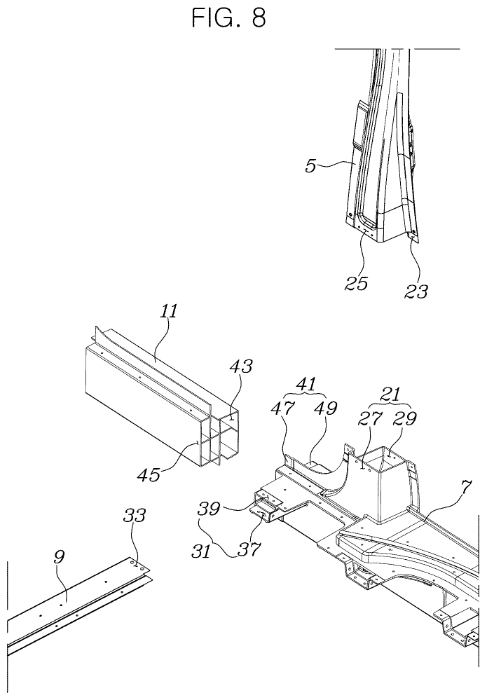

FIG. 9 is a view illustrating the components in FIG. 7 when viewed from the bottom side of the interior of the vehicle body.

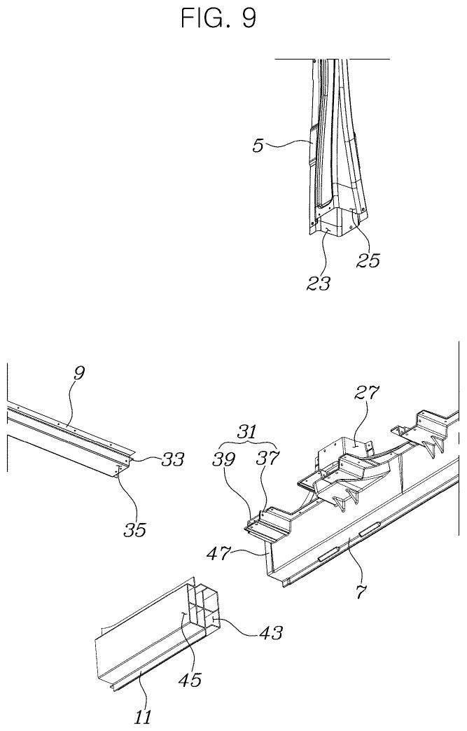

FIG. 10 is a view illustrating the components in FIG. 7 when viewed from the outer and bottom sides of the vehicle body.

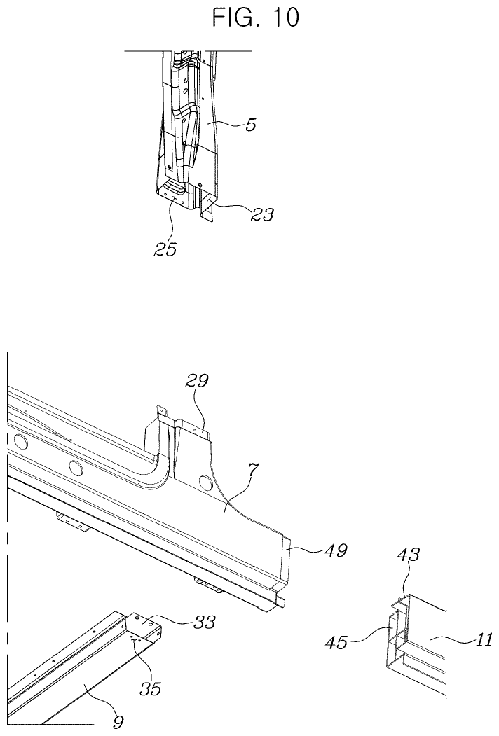

FIG. 11 is a view illustrating the components in FIG. 7 when viewed from the outer, bottom, and front sides of the vehicle body.

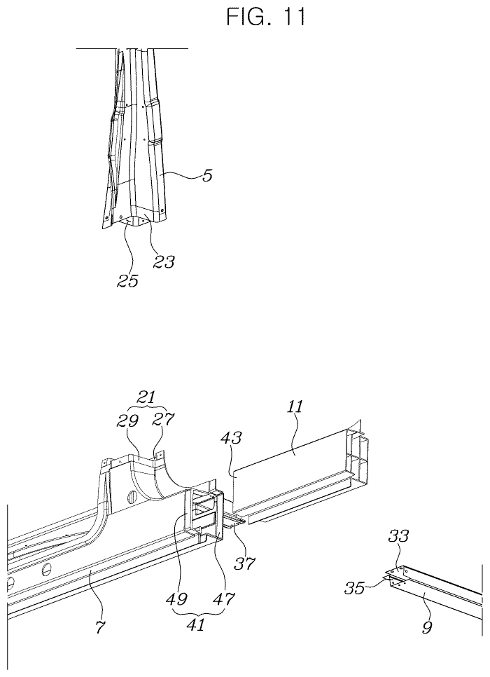

FIG. 12 is a view illustrating a vehicle body structure according to another embodiment of the present disclosure.

FIG. 13 is a cross-sectional view illustrating a rail member structure according to another embodiment of the present disclosure.

### DETAILED DESCRIPTION

Hereinafter, the embodiments disclosed in the present disclosure are described in detail with reference to the accompanying drawings. The same or similar constituent elements are assigned with the same reference numerals regardless of reference numerals. Additionally, repetitive descriptions thereof have been omitted.

The suffixes “module,” “unit,” “part,” and “portion” used to describe constituent elements in the following description are used together or interchangeably in order to facilitate the description, but suffixes the themselves do not have distinguishable meanings or functions.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function.

In the description of the embodiments disclosed in the present disclosure, the specific descriptions of publicly known related technologies have been omitted where it was determined that the specific descriptions may have obscured the subject matter of the embodiments disclosed in the present disclosure. In addition, it should be understood that the accompanying drawings are provided only to allow those having ordinary skill in the art to more readily understand the embodiments disclosed in the present disclosure. The technical spirit of the present disclosure is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as having different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof. However, the terms do not preclude the presence or addition of one or more other features, integers, steps, operations, elements, components, or combinations thereof.

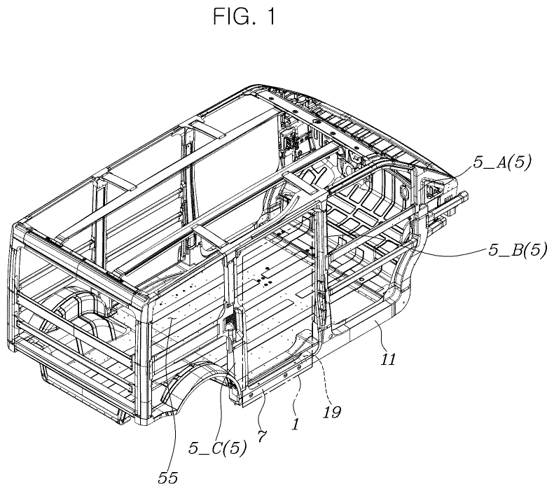

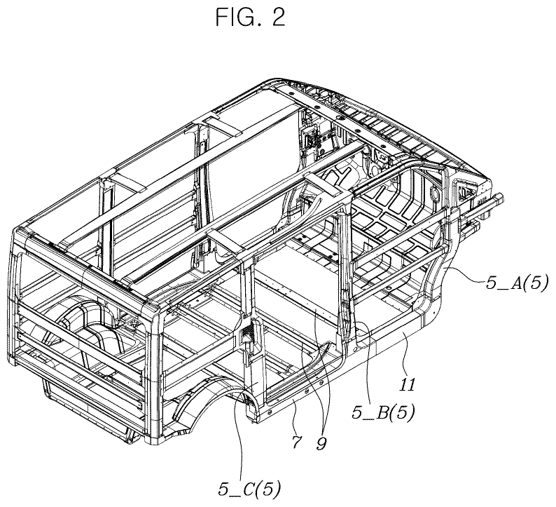

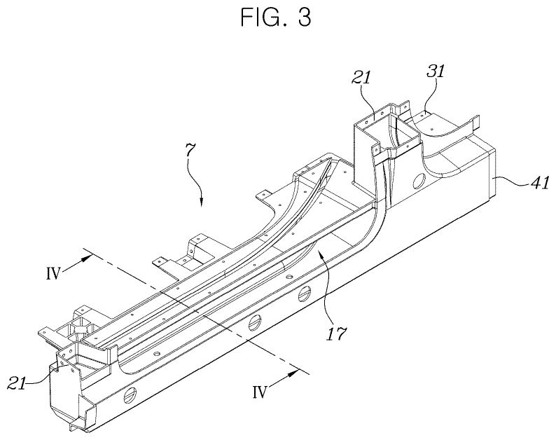

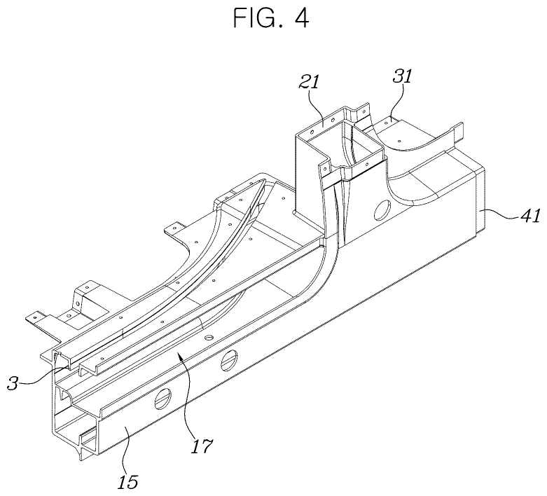

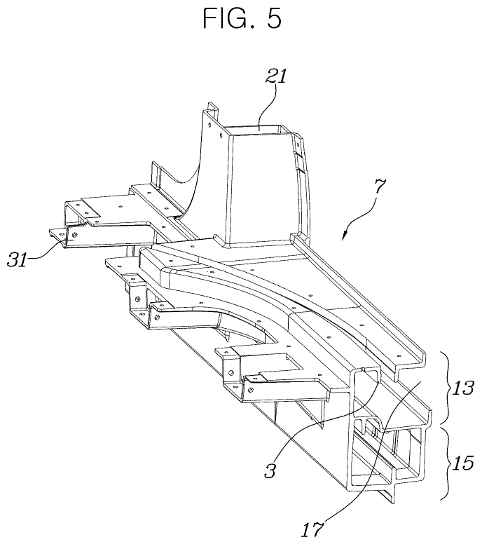

With reference to FIGS. 1-5, an embodiment of a vehicle body structure with a sliding door 1 according to the present disclosure includes a rail member 7 integrated with a door rail 3 and connected to a plurality of pillars 5. The plurality of pillars 5 is connected to an upper side of the rail member 7. The vehicle body structure also includes a plurality of body cross members 9 connected to a lateral side of the rail member 7.

In addition, a side sill 11 is coupled to a front side of the rail member 7.

In the present disclosure, the door rail 3 is not separately mounted on a vehicle body. A single vehicle body component, in which the rail member 7 integrated with the door rail 3 is coupled to the side sill 11, the pillars 5, and the body cross members 9, is provided. As a result, the configuration ensures sufficient rigidity of a portion where the door rail 3 for sliding the sliding door is provided. The configuration also facilitates a process of assembling the vehicle and reducing costs by significantly reducing the number of components.

Therefore, the rail member 7 may be configured as a single component manufactured by casting, 3D printing, and the like using a lightweight material such as an aluminum alloy.

The rail member 7 includes a rail forming part 13 configured to define the door rail 3. The rail member 7 also includes a strength reinforcement part 15 integrally provided below the rail forming part 13 and configured to define a transverse cross-section of the vehicle body that is a closed cross-section.

The strength reinforcement part 15 provided at a lower side of the rail member 7 has the closed cross-section to ensure high strength. As a result, the configuration ensures overall strength of the rail member 7 at a necessary level or higher.

In addition, in the present embodiment, the door rail 3 is formed at an upper side of the rail forming part 13. An opening portion 17 is provided between the door rail 3 and the strength reinforcement part 15 and opened to the outside of the vehicle body.

Therefore, a door arm 19 of the sliding door 1 is connected to the door rail 3 through the opening portion 17 and slides, such that an operation of sliding the sliding door 1 to open or close the sliding door 1 may be implemented.

The rail member 7 has a plurality of pillar coupling portions 21 protruding upward from the rail forming part 13 and coupled to the pillars 5 while defining a closed cross-section.

Each pillar 5 is formed so that a cross-section perpendicular to a longitudinal direction of the pillar 5 is formed as a closed cross-section. A first pillar lower end 23, which includes adjacent two or more outer peripheral walls among a plurality of outer peripheral walls that defines the closed cross-section of the pillar 5, protrudes relatively further downward than a second pillar lower end 25. The second pillar lower end 25 includes the remaining adjacent two or more outer peripheral walls.

In addition, each pillar coupling portion 21 of the rail member 7 that is coupled to a respective pillar 5 includes a first member upper end 27 protruding upward so as to be coupled to the second pillar lower end 25 of the pillar 5 while overlapping the second pillar lower end 25. Additionally, each pillar coupling portion 21 includes a second member upper end 29 recessed relatively downward from the first member upper end 27 so as to be coupled to the first pillar lower end 23 of the pillar 5 while overlapping the first pillar lower end 23.

In other words, the pillar 5 and the pillar coupling portion 21 of the rail member 7 are coupled while defining the closed cross-section. This is achieved by overlapping walls through the first member upper end 27, which is coupled to and overlaps the second pillar lower end 25, and the second member upper end 29, which is coupled to and overlaps the first pillar lower end 23. As a result, the configuration forms a very secure coupling structure.

The plurality of pillars 5 coupled to the rail member 7 may include a B-pillar 5_B and a C-pillar 5_C.

In this case, the B-pillar 5_B or the C-pillar 5_C includes the first pillar lower end 23 and the second pillar lower end 25, as described above, and is coupled to the plurality of pillar coupling portions 21 provided on the rail member 7 while defining the closed cross-sectional structure.

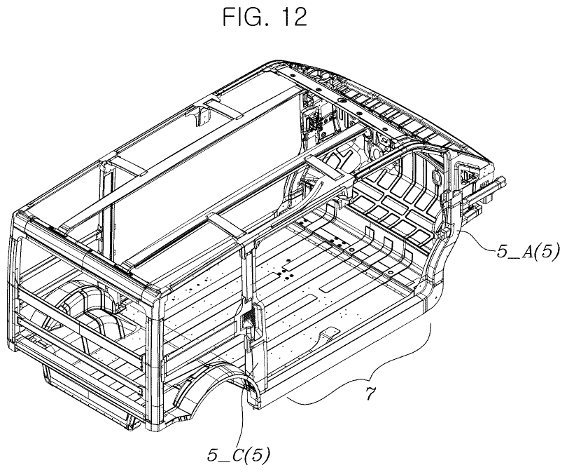

However, as illustrated in FIG. 12, the plurality of pillars 5 coupled to the rail member 7 may include the C-pillar 5_C and an A-pillar 5_A. The B-pillar 5_B between the A-pillar 5_A and the C-pillar 5_C may be excluded.

In other words, in the embodiment illustrated in FIG. 12, the rail member 7 has a structure further elongated in a forward/rearward direction than that in the embodiment in FIG. 1 so that the rail member 7 connects a lower end of the A-pillar 5_A and a lower end of the C-pillar 5_C.

The above-mentioned structure may be used for a vehicle equipped with two sliding doors 1.

In addition, the rail member 7 has a plurality of cross member coupling portions 31 protruding laterally toward the body cross members 9 and coupled to the body cross members 9 while defining closed cross-sections.

Each body cross member 9 is formed so that a cross-section perpendicular to a longitudinal direction of the body cross member 9 is formed as a closed cross-section. A first cross member lateral end 33 of the body cross member 9 protrudes relatively further laterally than a second cross member lateral end 35 of the body cross member 9. The first cross member lateral end 33 includes adjacent two or more outer peripheral walls among a plurality of outer peripheral walls that defines the closed cross-section of the body cross member 9. The second cross member lateral end 35 includes the remaining adjacent two or more outer peripheral walls.

In addition, each cross member coupling portion 31 of the rail member 7 coupled to a respective body cross member 9 includes a first member lateral end 37 further protruding laterally so as to be coupled to the second cross member lateral end 35 of the cross member while overlapping the second cross member lateral end 35. Additionally, each cross member coupling portion 31 includes a second member lateral end 39 recessed relatively laterally from the first member lateral end 37 so as to be coupled to the first cross member lateral end 33 of the body cross member 9 while overlapping the first cross member lateral end 33.

In other words, the body cross member 9 and the cross member coupling portion 31 of the rail member 7 are coupled while defining the closed cross-section. This is achieved by overlapping walls through the first member lateral end 37, which is coupled to and overlaps the second cross member lateral end 35, and the second member lateral end 39, which is coupled to and overlaps the first cross member lateral end 33. As a result, the configuration forms a very secure coupling structure.

In addition, the rail member 7 is coupled to the side sill 11 and elongated in the forward/rearward direction of the vehicle body. A side sill coupling portion 41 is provided at a front side of the rail member 7 and coupled to the side sill 11 while defining a closed cross-section.

The side sill 11 is formed so that a cross-section perpendicular to a longitudinal direction of the side sill 11 is formed as a closed cross-section. A first side sill rear end 43 further protrudes relatively rearward than a second side sill rear end 45. The first side sill rear end 43 includes adjacent two or more outer peripheral walls among a plurality of outer peripheral walls that defines the closed cross-section of the side sill 11. The second side sill rear end 45 includes the remaining adjacent two or more outer peripheral walls.

In addition, the side sill coupling portion 41 of the rail member 7 coupled to the side sill 11 includes a first member front end 47 further protruding forward so as to be coupled to the second side sill rear end 45 of the side sill 11 while overlapping the second side sill rear end 45. Additionally, the side sill coupling portion 41 includes a second member front end 49 recessed relatively rearward from the first member front end 47 so as to be coupled to the first side sill rear end 43 of the side sill 11 while overlapping the first side sill rear end 43.

Therefore, the side sill 11 and the side sill coupling portion 41 of the rail member 7 are coupled to have a structure for forming a closed cross-section. This is achieved by overlapping walls through the first member front end 47, which is coupled to and overlaps the second side sill rear end 45, and the second member front end, which is coupled to and overlaps the first side sill rear end 43. As a result, the configuration ensures very secure rigidity.

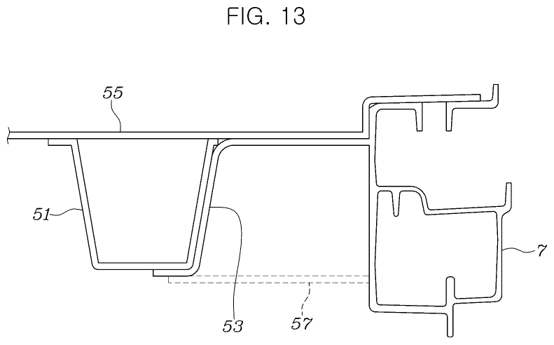

With reference to FIG. 13, the rail member 7 may further include a side flange 53 extending toward the inside of the vehicle and coupled to a floor longitudinal member 51.

The rail member 7 and the floor longitudinal member 51 are coupled to each other by the side flange 53, thereby ensuring greater rigidity of the rail member 7 against a broadside collision. The floor longitudinal member 51 is disposed below a floor panel 55 of the vehicle body and elongated in the forward/rearward direction of the vehicle body.

In the present embodiment, the side flange 53 of the rail member 7 is shaped to surround a sidewall and a lower portion of the floor longitudinal member 51, thereby defining a more robust support structure.

Further, as indicated by the dotted line in FIG. 13, a reinforcement panel 57 may be further provided between a lower side of the floor longitudinal member 51 and the rail member 7 and define a closed cross-section together with the side flange 53 to reinforce rigidity.

While the specific embodiments of the present disclosure have been illustrated and described, it should be apparent to those having ordinary skill in the art that the present disclosure may be variously modified and changed without departing from the technical spirit of the present disclosure defined in the appended claims.

What is claimed is:

1. A vehicle body structure with a sliding door, the vehicle body structure comprising:
a rail member integrated with a door rail;
a plurality of pillars coupled to an upper side of the rail member; and
a plurality of body cross members connected to a lateral side of the rail member.

2. The vehicle body structure of claim 1, wherein the rail member comprises:
a rail forming part configured to define the door rail; and
a strength reinforcement part integrally provided below the rail forming part and configured to define a transverse cross-section of a vehicle body that is a closed cross-section.

3. The vehicle body structure of claim 2, wherein the door rail is formed at an upper side of the rail forming part, and wherein an opening portion is provided between the door rail and the strength reinforcement part and opened to an outside of the vehicle body.

4. The vehicle body structure of claim 2, wherein the rail member has a plurality of pillar coupling portions protruding upward from the rail forming part and coupled to the plurality of pillars, respectively, while defining closed cross-sections.

5. The vehicle body structure of claim 4, wherein:
a pillar of the plurality of pillars is formed so that a cross-section perpendicular to a longitudinal direction of the pillar is formed as a closed cross-section;
a first lower end of the pillar, which includes adjacent two or more outer peripheral walls among a plurality of outer peripheral walls that defines the closed cross-section of the pillar, protrudes relatively further downward than a second lower end of the pillar including the remaining adjacent two or more outer peripheral walls; and
a pillar coupling portion of the plurality of pillar coupling portions of the rail member coupled to the pillar includes a first member upper end protruding upward so as to be coupled to the second lower end of the pillar while overlapping the second lower end, and a second member upper end recessed relatively downward from the first member upper end so as to be coupled to the first lower end of the pillar while overlapping the first lower end.

6. The vehicle body structure of claim 2, wherein the rail member has a plurality of cross member coupling portions protruding laterally toward the plurality of body cross members and coupled to the plurality of body cross members, respectively, while defining closed cross-sections.

7. The vehicle body structure of claim 6, wherein:
a body cross member of the plurality of body cross members is formed so that a cross-section perpendicular to a longitudinal direction of the body cross member is formed as a closed cross-section;
a first lateral end of the body cross member, which includes adjacent two or more outer peripheral walls among a plurality of outer peripheral walls that defines the closed cross-section of the body cross member, protrudes relatively further laterally than a second lateral end of the body cross member including the remaining adjacent two or more outer peripheral walls; and
a cross member coupling portion of the plurality of cross member coupling portions of the rail member coupled to the body cross member includes a first member lateral end protruding further laterally so as to be coupled to the second lateral end of the body cross member while overlapping the second lateral end, and a second member lateral end recessed relatively laterally from the first member lateral end so as to be coupled to the first lateral end of the body cross member while overlapping the first lateral end.

8. The vehicle body structure of claim 2, wherein the rail member is coupled to a side sill and elongated in a forward/rearward direction of the vehicle body, and wherein a side sill coupling portion is provided at a front side of the rail member and coupled to the side sill while defining a closed cross-section.

9. The vehicle body structure of claim 8, wherein:
the side sill is formed so that a cross-section perpendicular to a longitudinal direction of the side sill is formed as a closed cross-section;
a first rear end of the side sill, which includes adjacent two or more outer peripheral walls among a plurality of outer peripheral walls that defines the closed cross-section of the side sill, protrudes relatively further rearward than a second rear end of the side sill including the remaining adjacent two or more outer peripheral walls; and
the side sill coupling portion of the rail member coupled to the side sill includes a first member front end protruding further forward so as to be coupled to the second rear end of the side sill while overlapping the second rear end, and a second member front end recessed relatively rearward from the first member front end so as to be coupled to the first rear end of the side sill while overlapping the first rear end.

10. The vehicle body structure of claim 2, wherein the plurality of pillars coupled to the rail member includes a B-pillar and a C-pillar.

11. The vehicle body structure of claim 2, wherein the plurality of pillars coupled to the rail member includes a C-pillar and an A-pillar, and wherein a B-pillar between the A-pillar and the C-pillar is excluded.

12. The vehicle body structure of claim 2, wherein the rail member further includes a side flange extending toward an inside of a vehicle and coupled to a floor longitudinal member.

13. The vehicle body structure of claim 12, wherein the side flange of the rail member is shaped to surround a sidewall and a lower portion of the floor longitudinal member.

14. The vehicle body structure of claim 12, wherein a reinforcement panel is further provided between a lower side of the floor longitudinal member and the rail member and defines a closed cross-section together with the side flange to reinforce rigidity.
